(19) United States
(12) Patent Application Publication
(10) Pub. No.: US 2025/0283607 A1
(43) Pub. Date: Sep. 11, 2025

(54) COOKING APPLIANCE AND METHOD FOR INITIALIZING CONTROLLER TERMS FOR COOKING OPERATIONS

(71) Applicant: Haier US Appliance Solutions, Inc., Wilmington, DE (US)

(72) Inventor: Omar Santana, Louisville, KY (US)

(21) Appl. No.: 18/598,823

(22) Filed: Mar. 7, 2024

(51) Int. Cl. F24C 7/08; G05D 23/19; H05B 1/02

(52) U.S. Cl. CPC F24C 7/087; G05D 23/1917; H05B 1/0266; H05B 2213/07

(57) ABSTRACT

A cooking appliance includes at least one heating element to selectively supply heat to a cookware item; a temperature sensor configured to selectively monitor a temperature of the cookware item; and a controller operably connected with the at least one heating element and the temperature sensor, the controller configured to perform a heating operation. The heating operation includes determining a temperature setpoint; directing the at least one heating element based on the determined temperature setpoint over a preheating phase; determining one or more parameters for a feedback controlled cooking phase according to the determined temperature setpoint, the one or more parameters including at least one initial controller term value; and directing the at least one heating element according to the one or more determined parameters for a duration of the feedback controlled cooking phase.

### FIELD OF THE INVENTION

The present subject matter relates generally to cooking appliances, and more particularly to methods of operating cooking appliances according to thermal behaviors of cookware items.

### BACKGROUND OF THE INVENTION

Cooking appliances generally have one or more heating elements configured for heating a cookware item. The cookware item, e.g., a pot or a pan, may be positioned on or near the one or more heating elements and food products (including, e.g., food solids, liquid, or water) may be placed inside the cookware item for cooking. A controller may selectively energize the heating element(s) to provide thermal energy to the cookware item and the food products placed therein. Alternatively, certain cooking appliances, often referred to as induction cooktops, provide energy in the form of an alternating magnetic field which causes the cookware item to generate heat. In both types of appliances, a controller selectively energizes either the heating element(s) or a magnetic coil to heat the food products until they are properly cooked.

For cooking appliances that are capable of performing feedback controlled heating operations, one or more algorithms may be used to incorporate certain feedback information (e.g., temperature change, temperature rate of change, etc.) over a heating period to intelligently control a power level of the heating element(s). For instance, some heating operations may incorporate constant or fixed preheating phases during which the heating element is driven at a constant power level. When the cooking phase begins, controller terms (e.g., derivative, integral, etc.) may be initialized at zero when the feedback controlled operation begins. However, existing methods have several drawbacks, including inadequate controller output, large overshoots, and the like.

Accordingly, a cooking appliance and method of operating a cooking appliance that obviates one or more of the above-mentioned drawbacks would be desirable. In particular, a cooking appliance capable of adjusting one or more initial parameters of a heating operation would be useful.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a cooking appliance is provided. The cooking appliance may include at least one heating element to selectively supply heat to a cookware item; a temperature sensor configured to selectively monitor a temperature of the cookware item; and a controller operably connected with the at least one heating element and the temperature sensor, the controller configured to perform a heating operation. The heating operation may include determining a temperature setpoint; directing the at least one heating element based on the determined temperature setpoint over a preheating phase; determining one or more parameters for a feedback controlled cooking phase according to the determined temperature setpoint, the one or more parameters including at least one initial controller term value; and directing the at least one heating element according to the one or more determined parameters for a duration of the feedback controlled cooking phase.

In another exemplary aspect of the present disclosure, a method of operating a cooking appliance is provided. The cooking appliance may include at least one heating element and a temperature sensor. The method may include determining a temperature setpoint; directing the at least one heating element based on the determined temperature setpoint over a preheating phase; determining one or more parameters for a feedback controlled cooking phase according to the determined temperature setpoint, the one or more parameters including at least one initial controller term value; and directing the at least one heating element according to the one or more determined parameters for a duration of the feedback controlled cooking phase.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an oven range according to exemplary embodiments of the present disclosure.

FIG. 2 provides a side cut-away view of the exemplary oven range of FIG. 1.

FIG. 3 provides a graph illustrating a comparison of a cookware temperature, a sensor temperature, and controller terms over time for a cookware item according to exemplary embodiments of the present disclosure.

FIG. 4 provides a table illustrating a plurality of controller term values for a plurality of temperature setpoints according to exemplary embodiments of the present disclosure.

FIG. 5 provides a flow chart illustrating a method of operating a cooking appliance according to exemplary embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

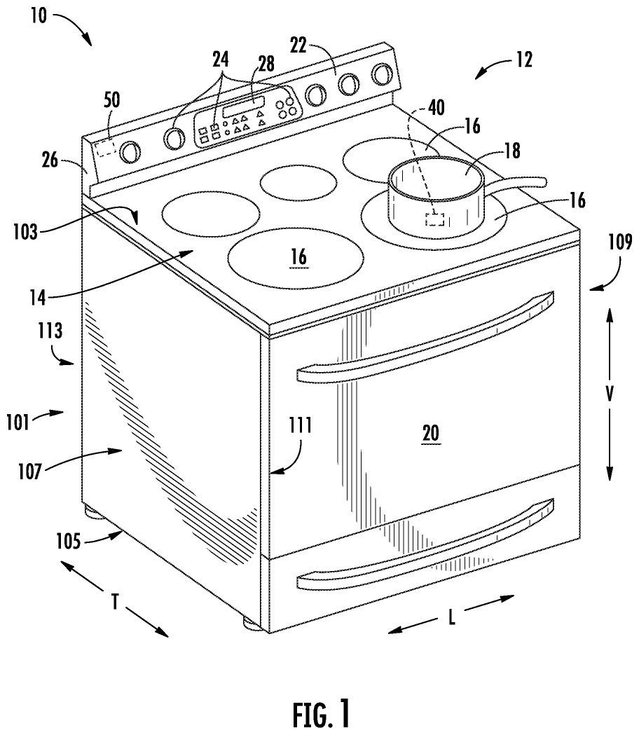

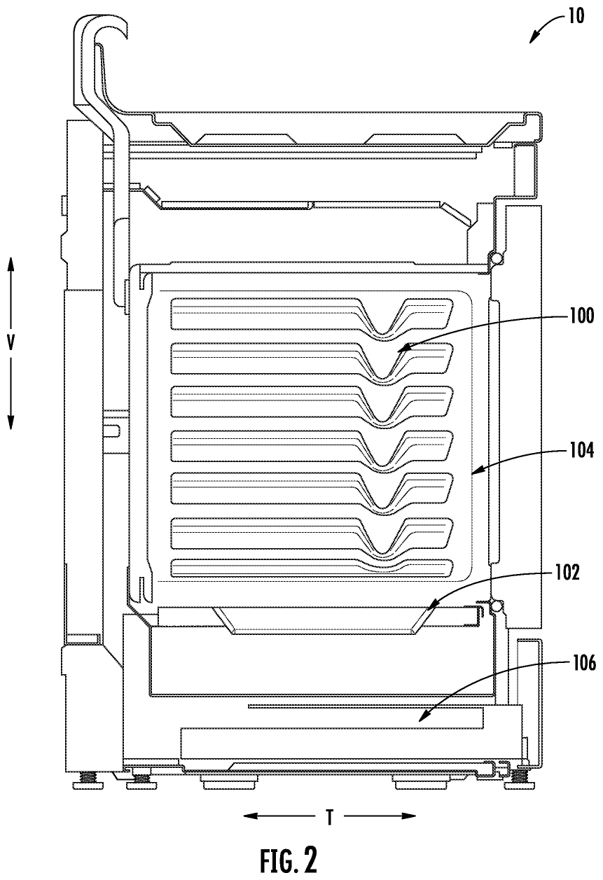

FIG. 1 provides a perspective view of a cooking appliance, or oven range 10, including a cooktop 12, and FIG. 2 provides a side cut-away view of the cooking appliance 10. Cooking appliance 10 is provided by way of example only and is not intended to limit the present subject matter to the arrangement shown in FIGS. 1 and 2. Thus, the present subject matter may be used with other range 10 and/or cooktop 12 configurations, e.g., double oven range appliances. As illustrated, cooking appliance 10 generally defines a vertical direction V, a lateral direction L, and a transverse direction T, each of which is mutually perpendicular, such that an orthogonal coordinate system is generally defined. Cooking appliance 10 may include a cabinet 101 that extends between a top 103 and a bottom 105 along the vertical direction V, between a left side 107 and a right side 109 along the lateral direction, and between a front 111 and a rear 113 along the transverse direction T.

A cooking surface 14 of cooktop 12 may include a plurality of heating elements 16. For the embodiment depicted, cooktop 12 includes five heating elements 16 spaced along cooking surface 14. Heating elements 16 may be electric heating elements and are positioned at, e.g., on or proximate to, the cooking surface 14. In certain exemplary embodiments, cooktop 12 is a radiant cooktop with resistive heating elements or coils mounted below cooking surface 14. However, in other embodiments, the cooktop appliance 12 includes other suitable shape, configuration, and/or number of heating elements 16, for example, cooktop 12 may be an open coil cooktop with heating elements 16 positioned on or above surface 14. Additionally or alternatively, in other embodiments, cooktop 12 may include any other suitable type of heating element 16, such as an induction heating element. Each of the heating elements 16 may be the same type of heating element 16, or cooktop 12 may include a combination of different types of heating elements 16.

As mentioned, heating element 16 may be an induction style heating element. Thus, as would be understood by those skilled in the art, appliance 10 may supply a current to heating element 16 (e.g., such as a Lenz coil). As such, current may pass through heating element 16 to generate a magnetic field. The magnetic field may be a high frequency circulating magnetic field. The magnetic field may be directed towards and through cooktop appliance 12 to a cookware item (e.g., cookware item 18, described below). In particular, when the magnetic field penetrates cookware item 18, the magnetic field induces a circulating electrical current within cookware item 18. The material properties of cookware item 18 may restrict a flow of the induced electrical current and convert the induced electrical current into heat within cookware item 18. As cookware item 18 heats up, contents of cookware item 18 contained therein heat up as well. In such a manner, the induction heating element can cook the contents of cookware item 18.

As shown in FIG. 1, a cooking utensil (or cookware item) 18, such as a pot, pan, or the like, may be placed on a heating element 16 to heat cookware item 18 and cook or heat food items placed within cookware item 18. Cooking appliance 10 may also include a door 20 that permits access to a cooking chamber 104 of oven range 10, e.g., for cooking or baking of food items therein. A control panel 22 having controls 24 may permit a user to make selections for cooking of food items. Although shown on a backsplash or back panel 26 of oven range 10, control panel 22 may be positioned in any suitable location.

Controls 24 may include buttons, knobs, and the like, as well as combinations thereof, and/or controls 24 may be implemented on a remote user interface device such as a smartphone. As an example, a user may manipulate one or more controls 24 to select a temperature and/or a heat or power output for each heating element 16 and the cooking chamber 104. The selected temperature or heat output of heating element 16 affects the heat transferred to cookware item 18 placed on heating element 16. A display 28 may be provided (e.g., on or in control panel 22). Display 28 may display information regarding cooking operations or inputs from a user regarding the cooking operation. Display 28 may be any suitable display capable of providing visual feedback, such as a liquid crystal display (LCD), a light emitting diode (LED) display, a segmented display, or the like. Additionally or alternatively, display 28 may be a touch display capable of receiving touch inputs from a user.

Cooktop appliance 12 may further include or be in operative communication with a processing device or a controller 50 that may be generally configured to facilitate appliance operation. In this regard, control panel 22, controls 24, and display 28 may be in communication with controller 50 such that controller 50 may receive control inputs from controls 24, may display information using display 28, and may otherwise regulate operation of cooking appliance 10. For example, signals generated by controller 50 may operate cooking appliance 10, including any or all system components, subsystems, or interconnected devices, in response to the position of controls 24 and other control commands. Control panel 22 and other components of appliance 10 may be in communication with controller 50 via, for example, one or more signal lines or shared communication busses. In this manner, Input/Output (“I/O”) signals may be routed between controller 50 and various operational components of appliance 10.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 50 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 50 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 50 may be operable to execute programming instructions or micro-control code associated with an operating cycle of cooking appliance 10. In this regard, the instructions may be software or any set of instructions that when executed by the processing device, cause the processing device to perform operations, such as running one or more software applications, displaying a user interface, receiving user input, processing user input, etc. Moreover, it should be noted that controller 50 as disclosed herein is capable of and may be operable to perform any methods, method steps, or portions of methods as disclosed herein. For example, in some embodiments, methods disclosed herein may be embodied in programming instructions stored in the memory and executed by controller 50.

The memory devices may also store data that can be retrieved, manipulated, created, or stored by the one or more processors or portions of controller 50. The data can include, for instance, data to facilitate performance of methods described herein. The data can be stored locally (e.g., on controller 50) in one or more databases and/or may be split up so that the data is stored in multiple locations. In addition, or alternatively, the one or more database(s) can be connected to controller 50 through any suitable network(s), such as through a high bandwidth local area network (LAN) or wide area network (WAN). In this regard, for example, controller 50 may further include a communication module or interface that may be used to communicate with one or more other component(s) of appliance 10, controller 50, an external appliance controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

Cooking appliance 10 may include a temperature sensor 40. Temperature sensor 40 may be configured to selectively sense a temperature of a cookware item (e.g., cookware item 18) as it is heated. For instance, temperature sensor 40 may be integrally formed with cooking appliance 10 (e.g., within cooktop 12, within cooking chamber 104, etc.). In some embodiments, temperature sensor 40 is operably connected to cooking appliance 10 (e.g., via a port or socket, via a remote connection, etc.). For one example, temperature sensor 40 is provided within cookware item 18 and operably connected to controller 50 during a cooking operation. Temperature sensor 40 may monitor a temperature of cookware item 18 or a food item provided within cookware item 18. Accordingly, temperature sensor 40 may deliver signals (e.g., voltage signals) representing the temperature of cookware item 18 to controller 50. The signals may be sent according to a predetermined frequency (e.g., at predetermined time intervals). Thus, controller 50 may analyze a temperature or temperature change of cookware item 18.

As used herein, “temperature sensor” or the equivalent is intended to refer to any suitable type of temperature measuring system or device positioned at any suitable location for measuring the desired temperature. Thus, for example, temperature sensor 40 may be any suitable type of temperature sensor, such as a thermistor, a thermocouple, a resistance temperature detector, a semiconductor-based integrated circuit temperature sensor, etc. In addition, temperature sensor 40 may be positioned at any suitable location and may output a signal, such as a voltage, to a controller that is proportional to or indicative of the temperature being measured. Although exemplary positioning of temperature sensors is described herein, it should be appreciated that appliance 10 may include any other suitable number, type, and position of temperature or other sensors according to alternative embodiments.

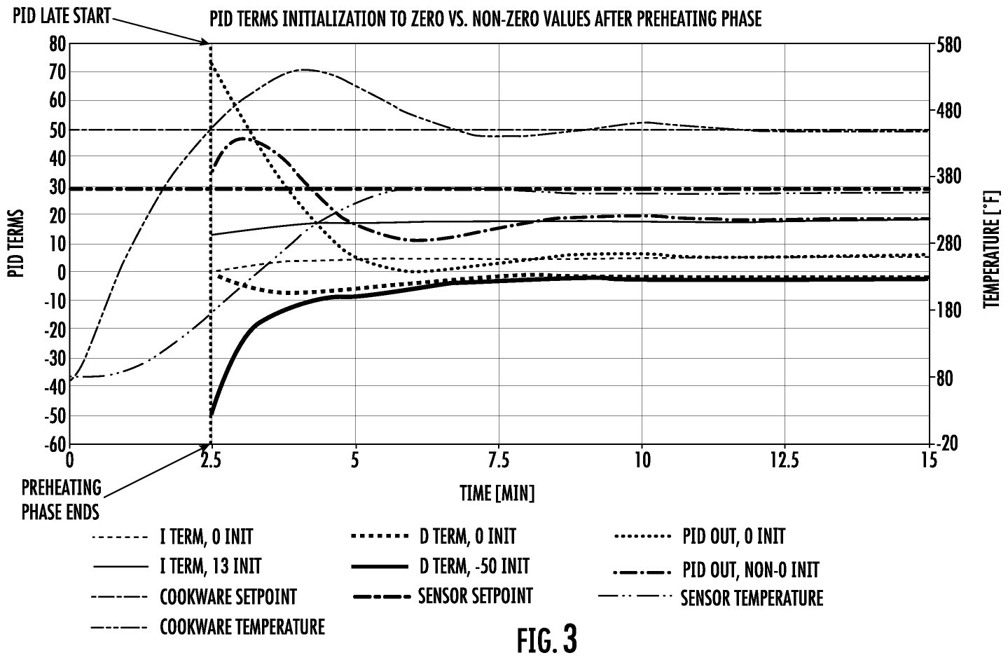

FIG. 3 provides a graph illustrating a cookware item temperature and setpoint, a sensor temperature and setpoint, an integral term, a derivative term, and a total proportion-integral-derivative (PID) output value for an exemplary cookware item. It should be noted that a proportional term is also incorporated into the PID output value but not shown individually in the graph. In detail, as mentioned above, temperature sensor 40 may monitor the temperature of cookware item 18 over the course of the cooking or heating operation. The heating operation may include a preheating phase and a cooking phase. The preheating phase may be a constant heating preheating phase. For instance, during the preheating phase, heating element 16 may be driven (e.g., powered) at a constant predetermined power level for a duration of the preheating phase. Accordingly, a controlled temperature increase may be exhibited by cookware item 18.

According to at least some embodiments, the preheating phase may include a plurality of stages. For instance, the preheating phase may include a first stage and a second stage following the first stage. It should be understood that the preheating phase may include any suitable number of stages as specific instances warrant, and the disclosure is not limited to the examples given and described herein. The first stage (stage A) may include a first set of attributes for the heating element while the second stage (stage B) includes a second set of attributes for the heating element.

Stage A may have a first duration and stage B may have a second duration. The first duration may be different from the second duration. For instance, the first duration may be shorter than the second duration. As mentioned above, additional stages may be included as well, each additional stage having a duration (e.g., a unique duration or a duration equal to that of one or more of the other durations).

Moreover, each individual stage may include a unique power level. In detail, stage A may be associated with a first determined power level (power level 1A) while stage B is associated with a second determined power level (power level 1B). In some instances, the first determined power level (e.g., power level 1A) is greater than the second determined power level (e.g., power level 1B).

The cooking phase may be a feedback controlled cooking phase. In detail, the cooking phase may intelligently adjust one or more parameters according to feedback with respect to cookware item 18, a food being cooked, cooking appliance 10, or the like. Temperature sensor 40 may continually send temperature signals to controller 50 which may then determine, for instance, an error value associated with the feedback controlled cooking phase. The error value may be a difference between a temperature setpoint and an actual observed temperature (e.g., via temperature sensor 40). The error value may be substituted into a feedback equation to determine an adjustment to be made to a control variable. For instance, the control variable may be a power level of heating element 16.

According to at least some embodiments, controller 50 includes a closed-loop feedback control algorithm. The closed-loop feedback control algorithm may be a proportional-integral-derivative (PID) algorithm or equation (e.g., equation or set of equations). In some embodiments, the algorithm may include a proportional algorithm, a proportional-integral algorithm, a proportional-derivative algorithm, or any suitable combination of terms. The PID controller may determine a proportional term (P), an integral term (I), and a derivative term (D). The PID algorithm may be:

$$CV = P + I + D$$

where CV is a controlled variable (e.g., power input to heating element 16), P is the proportional term, I is the integral term, and D is the derivative term. As can be seen, adding each of the P, I, and D terms generates a value for the power level of heating element 16. Each of the P, I, and D terms may be found as follows:

$$P = {K}_{p} * e$$

$$I = {I}_{prev} + {K}_{i} * e * {T}_{s}$$

$$D = {K}_{d} * ( e - {e}_{prev} ) / {T}_{s}$$

where Kₚ is a proportional gain value, Kᵢ is an integral gain value, K_{d} is a derivative gain value, e is an error value (e.g., a difference between a temperature setpoint and an observed temperature), Tₛ is a sampling time or sampling time rate (e.g., a rate at which a discrete system samples inputs), Iₚᵣₑᵥ is a previous integral term (e.g., at the previous sampling event), and eₚᵣₑᵥ is a previous error value (e.g., at the previous sampling event). As noted above, however, in some instances any suitable combination of P, I, and D terms may be incorporated into the algorithm.

In some instances, the derivative (D) term may be susceptible to high levels of noise. Thus, large oscillations of the D term may be observed throughout the feedback controlled cooking phase. Accordingly, the D term may be subjected to a filtering to reduce the noise and obtain a more steady, predictable term over the cooking phase. For one example:

$${D}_{filtered} = α * D + ( 1 - α ) * {D}_{{filtered}_{prev}}$$

where D_{filtered} is the filtered D term, D_{filteredprev} is the previous filtered D term (e.g., from a measuring point immediately preceding the current measuring point [previous sampling event]), and α is a filter smoothing factor, such that 0≤α≤1. As would be understood, a smaller value of a (e.g., closer to 0) would result in greater smoothing of the D term. Additionally or alternatively, the filtered D term incorporates previous D terms to provide smoother adjustments to the D term of the PID controller algorithm. With a smoother D term, fluctuations of the PID controller outputs may be reduced. Thus, the PID algorithm may be adjusted to:

$$CV = P + I + {D}_{filtered}$$

According to some instances, each of the I term and the D term may be initialized (e.g., to a non-zero value) at the completion of the preheating phase before initiating the feedback controlled cooking phase. As shown in FIG. 3, for instance, the feedback controlled cooking phase may initiate at 2.5 minutes (e.g., at the conclusion of the preheating phase). At the initiation of the cooking phase, the/term and the D term are each initialized to a non-zero value. According to the example provided herein, the/term is initialized to a positive value while the D term is initialized to a negative value. It should be understood, however, that each of the/term and the D term may be initialized to any suitable value, and the disclosure is not limited to the examples provided herein.

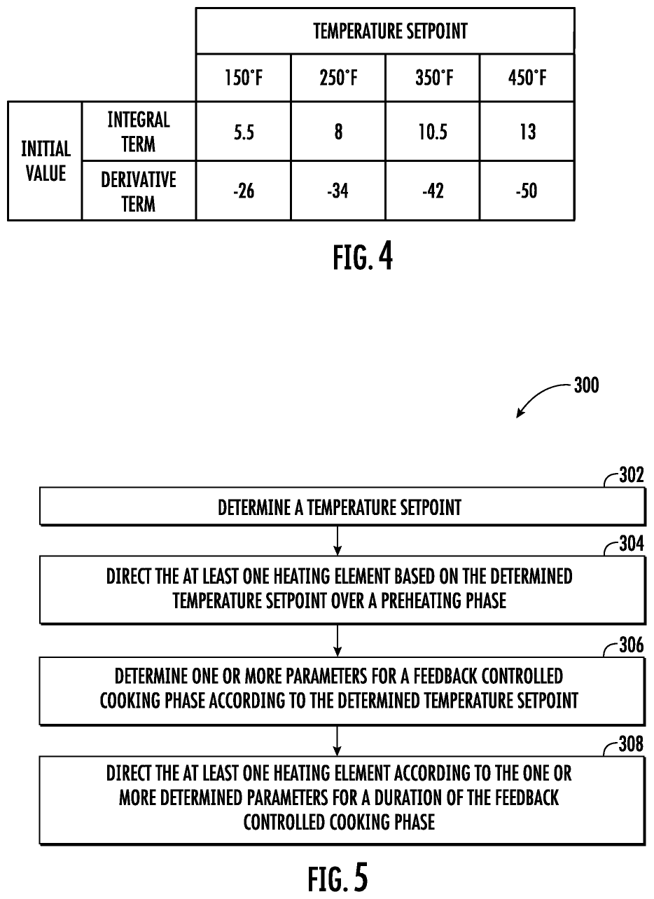

FIG. 4 provides a table illustrating a plurality of initialized values according to a plurality of temperature setpoints. As mentioned, certain cooking or heating operations may be performed according to a requested, determined, or calculated temperature setpoint (e.g., based on a food to be cooked, a cooking mode, etc.). For instance, the temperature setpoint may be determined according to an input (e.g., a user input), a food type to be cooked, a selected cooking mode, or the like. Each individual temperature setpoint may thus be associated with unique or individualized initial term values (e.g., for the/term and the D term). Accordingly, the initial term values may be stored within a lookup table, as exemplary shown in FIG. 4. Additionally or alternatively, the initial term values may be calculated for certain temperature setpoints. For example, if a temperature setpoint is between two temperature setpoints stored within the table, the initial term values may be calculated (e.g., interpolated, extrapolated, etc.) from the two known initial term values corresponding to the known temperature setpoints.

Now that the construction of cooking appliance 10 and a configuration of controller 50 according to exemplary embodiments have been presented, an exemplary method 300 of operating a cooking appliance will be described. Although the discussion below refers to the exemplary method 300 of operating cooking appliance 10, one skilled in the art will appreciate that the exemplary method 300 is applicable to the operation of a variety of other cooking appliances. In exemplary embodiments, the various method steps as disclosed herein may be performed by controller 50 or a separate, dedicated controller. Additionally or alternatively, the various method steps may be performed in a different order, including additional steps or omitting certain steps according to specific embodiments.

At step 302, method 300 may include determining a temperature setpoint. In detail, a user may communicate with the cooking appliance (e.g., cooking appliance 10) a desire to initiate a cooking operation, a heating operation, or the like. For example, the cooking operation may include a feedback controlled heating phase incorporating a PID algorithm to continually monitor the heating operation and perform adjustments as needed. For instance, as will be discussed, the cooking operation may include a preheating phase before the heating phase. According to at least some embodiments, the preheating phase may not incorporate feedback control (e.g., PID feedback control). The user may manually enter a temperature setpoint (e.g., a temperature at which the user desires to have the item cooked). Thus, using a user interface (e.g., control panel 22), the user may enter a specific cooking temperature as the temperature setpoint (e.g., 250° F., 300° F., 350° F., etc.). In additional or alternative embodiments, the user may provide information regarding a specific food item to be cooked (e.g., eggs, meat, vegetables, etc.). For instance, the cooking appliance may include features for selecting predetermined food items from the user interface or the cooking appliance may include a remote connectivity (e.g., wireless fidelity [WiFi], Bluetooth®, etc.), through which the user may select a food item (e.g., via a remote device). Further still, the user may input a particular recipe to be cooked on or in the cooking appliance. The temperature setpoint may be stored within the cooking appliance (e.g., within a controller or a memory therein).

At step 304, method 300 may include directing the at least one heating element based on the determined setpoint over a preheat or preheating phase. As mentioned above, the cooking or heating operation may include each of the preheating phase and the cooking phase. The preheating phase may include operating the at least one heating element at a constant power level over a duration of the preheating phase. For instance, method 300 may include determining the power level for the at least one heating element based on the determined temperature setpoint. Accordingly, the power level of the at least one heating element may vary based on the desired cooking temperature, the food being cooked, a particular recipe, or the like. Accordingly, the at least one heating element may then be directed at the determined power level for the duration of the preheating phase.

According to some embodiments, a total duration of the preheating phase may be predetermined. For instance, the preheating phase may be set to a fixed time length. In additional or alternative embodiments, the preheating phase may be determined to be completed when a temperature at the temperature sensor reaches a sensor temperature setpoint (e.g., target temperature). The sensor temperature setpoint may be different from the determined setpoint. For instance, the sensor temperature setpoint or target may be based on the determined setpoint mentioned above.

At step 306, method 300 may include determining one or more parameters for a feedback controlled cooking phase according to the determined temperature setpoint. For instance, as described above, the feedback controlled cooking phase may incorporate a PID control algorithm utilizing a proportional term (P), an integral term (I), and a derivative term (D). Thus, the one or more parameters for the feedback controlled cooking phase may include an initial term value for at least one of the I term or the D term. According to some embodiments, the initial term value or values may be retrieved from a lookup table (e.g., as shown in FIG. 4). Thus, based on the determined temperature setpoint, the initial term value or values may be retrieved and incorporated into the control algorithm.

Further, as mentioned above, in the instance where an initial D term is incorporated, the D term may be subjected to a smoothing operation. Thus, the initial D term may be retrieved from the table, incorporated into the control algorithm, and further incorporated into an additional calculation to determine a subsequent smoothed D term. Advantageously, smoother adjustments to the heating element may be incorporated throughout the feedback controlled cooking phase.

Method 300 may include initializing the PID algorithm with at least one of the initial integral term value or the initial derivative term value. For instance, after determining the one or more parameters, the method may incorporate at least one of the initial term values into the feedback control algorithm. In some instances, only the initial integral term value is incorporated into the feedback control algorithm, while the initial derivative term value remains initialized at zero. In additional or alternative embodiments, only the initial derivative term value is incorporated into the feedback control algorithm, while the initial integral term value remains initialized at zero.

At step 308, method 300 may include directing the at least one heating element according to the one or more determined parameters for a duration of the feedback controlled cooking phase. Upon determining the appropriate initial values for at least one of the I term or the D term for the cooking phase using the temperature setpoint, method 300 may initiate the feedback controlled cooking phase (e.g., at the conclusion of the preheating phase). At this stage, the at least one heating element may be controlled according to the closed-loop control system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooking appliance comprising:
at least one heating element to selectively supply heat to a cookware item;
a temperature sensor configured to selectively monitor a temperature of the cookware item; and
a controller operably connected with the at least one heating element and the temperature sensor, the controller configured to perform a heating operation, the heating operation comprising:
determining a temperature setpoint;
directing the at least one heating element based on the determined temperature setpoint over a preheating phase;
determining one or more parameters for a feedback controlled cooking phase according to the determined temperature setpoint, the one or more parameters comprising at least one initial controller term value; and
directing the at least one heating element according to the one or more determined parameters for a duration of the feedback controlled cooking phase.

2. The cooking appliance of claim 1, wherein determining the one or more parameters for a feedback controlled cooking phase comprises:
retrieving the at least one initial controller term value from a lookup table.

3. The cooking appliance of claim 1, wherein the at least one initial controller term value comprises:
an initial integral term value; and
an initial derivative term value.

4. The cooking appliance of claim 3, wherein the initial derivative term value comprises a filtered derivative term value using a filter smoothing factor.

5. The cooking appliance of claim 3, wherein the feedback controlled cooking phase comprises a closed-loop proportional-integral-derivative (PID) algorithm.

6. The cooking appliance of claim 5, wherein the heating operation further comprises:
initializing the PID algorithm with at least one of the initial integral term value or the initial derivative term value after determining the one or more parameters for the feedback controlled cooking phase.

7. The cooking appliance of claim 1, wherein determining the temperature setpoint comprises at least one of:
receiving an input comprising the temperature setpoint;
retrieving the temperature setpoint based on a food type; or
determining the temperature setpoint based on a selected cooking mode.

8. The cooking appliance of claim 1, wherein directing the at least one heating element based on the temperature setpoint over the preheating phase comprises:
determining at least one power level for the at least one heating element based on the determined temperature setpoint; and
directing the at least one heating element at the at least one determined power level for a duration of the preheating phase.

9. The cooking appliance of claim 8, wherein the at least one determined power level comprises a first power level and a second power level, and wherein the at least one heating element is directed at the first power level for a first stage of the preheating phase and directed at the second power level for a second stage of the preheating phase.

10. A method of operating a cooking appliance, the cooking appliance comprising at least one heating element and a temperature sensor, the method comprising:
determining a temperature setpoint;
directing the at least one heating element based on the determined temperature setpoint over a preheating phase;
determining one or more parameters for a feedback controlled cooking phase according to the determined temperature setpoint, the one or more parameters comprising at least one initial controller term value; and
directing the at least one heating element according to the one or more determined parameters for a duration of the feedback controlled cooking phase.

11. The method of claim 10, wherein determining the one or more parameters for a feedback controlled cooking phase comprises:
retrieving the at least one initial controller term value from a lookup table.

12. The method of claim 10, wherein the at least one initial controller term value comprises:
an initial integral term value; and
an initial derivative term value.

13. The method of claim 12, wherein the initial derivative term value comprises a filtered derivative term value using a filter smoothing factor.

14. The method of claim 12, wherein the feedback controlled cooking phase comprises a closed-loop proportional-integral-derivative (PID) algorithm.

15. The method of claim 14, further comprising:
initializing the PID algorithm with at least one of the initial integral term value or the initial derivative term value after determining the one or more parameters for the feedback controlled cooking phase.

16. The method of claim 10, wherein determining the temperature setpoint comprises at least one of:
receiving an input comprising the temperature setpoint;
retrieving the temperature setpoint based on a food type; or
determining the temperature setpoint based on a selected cooking mode.

17. The method of claim 10, wherein directing the at least one heating element based on the temperature setpoint over the preheating phase comprises:
determining at least one power level for the at least one heating element based on the determined temperature setpoint; and
directing the at least one heating element at the at least one determined power level for a duration of the preheating phase.

18. The method of claim 17, wherein the at least one determined power level comprises a first power level and a second power level, and wherein the at least one heating element is directed at the first power level for a first stage of the preheating phase and directed at the second power level for a second stage of the preheating phase.
